(19) United States
(12) Patent Application Publication
(10) Pub. No.: US 2005/0006513 A1
(43) Pub. Date: Jan. 13, 2005

(54) Apparatus for centering a tape cartridge hub

(75) Inventor: Leslie G. Christie JR., Greeley, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P., Houston, TX (US)

(21) Appl. No.: 10/612,361

(22) Filed: Jul. 1, 2003

(51) Int. Cl. G03B 23/02

(52) U.S. Cl. 242/338

(57) ABSTRACT

An alignment probe engages an opening in a tape cartridge to center the hub of the cartridge with the hub of a tape drive. The alignment probe can be spring-loaded to accommodate cartridges that are not configured with an opening in the center of the hub. The alignment probe can be positioned in the spindle of the tape drive, and chamfered at the tip to engage the opening in the cartridge as the cartridge is inserted in the tape drive.

### BACKGROUND OF THE INVENTION

Many different types of cartridge storage and handling systems exist and are being used to store data cartridges (and other types of cartridges) at known locations and to retrieve desired cartridges so that data may be written to and/or read from the cartridges. Such data storage and handling systems are often referred to as “autochangers” or “juke box” data storage systems, particularly if they accommodate a large number of individual cartridges.

An autochanger storage system typically includes cartridge storage racks or magazines to provide storage locations for the cartridges. The magazines are commonly arranged so that they form one or more vertical stacks of storage slots. A cartridge read/write device may be located adjacent the cartridge stack, although the read/write device can be positioned at any convenient location. The storage system may also include a cartridge access device for accessing the various cartridges, and a positioning device for moving the access device between the storage slots and the read/write device.

When a host computer system issues a request for data contained on a particular cartridge, a control system associated with the access device actuates the positioning system to move the access device adjacent the desired cartridge. The access device then removes the cartridge from the magazine and carries it to the read/write device. The access device inserts the selected cartridge into the read/write device so that the host computer may thereafter read data from, or write data to, the cartridge. After the read/write operation is complete, the access device removes the cartridge from the read/write device and returns it to a specified location in the cartridge storage rack.

Although various operational modes are possible, storage systems commonly have the read/write device in a fixed location and use a moveable positioning system to transport cartridges between magazines and the read/write devices. The positioning system is typically a robotic device that moves along a guideway in an X, Y, and/or rotary motion.

Single spool tape cartridges are a popular alternative to dual spool cartridges because the single spool cartridges are less expensive to manufacture and require less storage space. In fact, single spool cartridge drives are the preferred design for high-capacity tape-based data backup solutions for data processing systems. Using 600 meters of 12.7 mm-wide tape wound on an 100 millimeter diameter spool, a single spool cartridge can store 300 or more gigabytes of data.

One disadvantage associated with the single spool tape cartridges is the tolerances that are associated between the cartridge tape reel and the cartridge case. The tape reel must have ample clearance within the cartridge case to rotate without rubbing. The result is the cartridge reel can move within the cartridge case. Also the cartridge reel has a locking feature that keeps the cartridge reel from turning then a drive flange is not engaged. As a result, in some conditions, the tape reel can be off center. This off-center condition happens with a much higher frequency when a tape drive is oriented so that the tape cartridges are loaded and unloaded on their side. This side-loading orientation is commonly used by many tape library manufacturers. An off-center tape reel can cause a mismatch between the cartridge tape reel and components in the tape drive that rotate the tape reel. When a cartridge is loaded in a tape drive, a drive mechanism in the tape drive attempts to engage a corresponding drive mechanism on the cartridge reel. Slippage will occur when the drive mechanisms are not properly engaged, resulting in a misload error.

### SUMMARY

In accordance with some embodiments, a device for aligning a hub comprises a spindle that rotates the hub. A spring-loaded alignment probe is mounted in the spindle to engage an opening in the hub.

In accordance with other embodiments a storage device comprises a tape, drive with a spindle and a probe positioned in the spindle. The probe engages an opening in the center of a hub in a cartridge as the cartridge is inserted in the tape drive.

In accordance with further embodiments, a method for aligning a cartridge hub in a tape drive is provided. The cartridge includes an opening for receiving an alignment probe. The alignment probe engages the opening in the cartridge to align the cartridge hub with a desired position as the cartridge is inserted in the tape drive. -

In accordance with still further embodiments, an apparatus comprises means for mounting an alignment probe so that the alignment probe engages an opening in a cartridge, and means for spring-loading the probe.

### BRIEF DESCRIPTION OF THE DRAWINGS

Embodiments of the invention relating to both structure and method of operation, may best be understood by referring to the following description and accompanying drawings.

FIG. 1A is a cross-sectional side view of an embodiment of a hub-centering device.

FIG. 1B is a cross-sectional side view of a stem and hub for the hub-centering device of FIG. 1A.

FIG. 2A is a perspective view of the bottom of a single spool tape cartridge.

FIG. 2B is a cross-sectional side view of the tape cartridge of FIG. 2A.

FIG. 3 is a cross-sectional side view of the hub-centering device of FIG. 1 engaging the hub of the cartridge of FIG. 2A.

FIG. 4 is a cross-sectional side view of the hub centering device of FIG. 1 engaging the hub of a conventional cartridge.

FIG. 5 is a cut-away top plan view of a single spool tape cartridge drive having a single spool tape cartridge inserted therein.

FIG. 6 is a schematic three-dimensional pictorial diagram showing an example of a media storage library system.

FIG. 7 is a top view of an embodiment of a cartridge storage system showing the access device of FIG. 1 in various positions.

### DETAILED DESCRIPTION

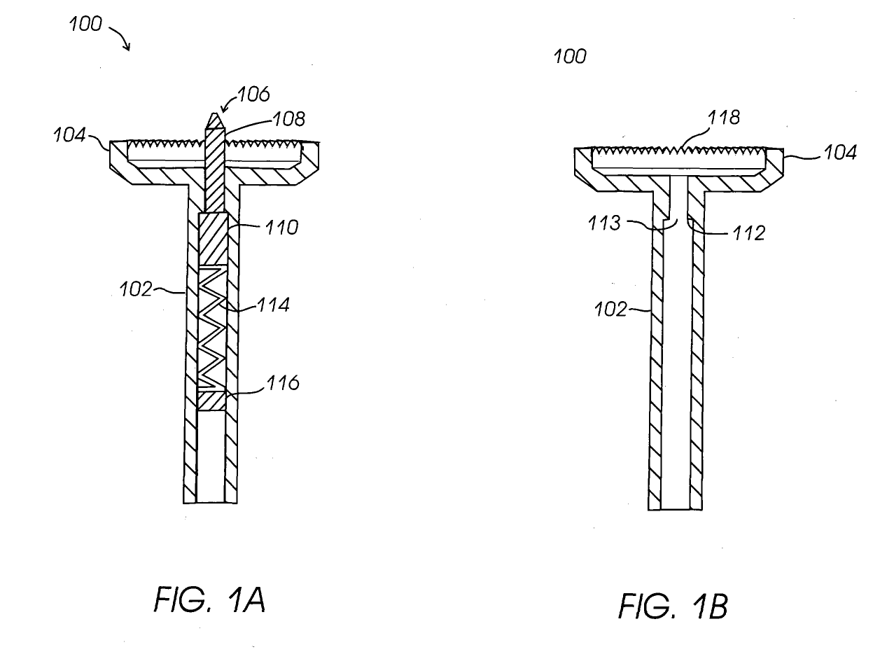

Referring to FIGS. 1A and 1B, FIG. 1A is a cross-sectional side view of an embodiment of a device for aligning the hub of a cartridge is shown as spindle 100 including stem 102 and hub 104. A portion of alignment probe 106 is positioned in a hollow portion of stem 102, and alignment probe 106 includes tip 108 extending through a portion of stem 102 and hub 104. The other end of tip 108 is mounted to base 110. FIG. 1B is a cross-sectional side view of stem 102 and hub 104 without alignment probe 106. Stem 102 includes a stop portion 112, as best shown in FIG. 1B, formed by an opening 113 that is large enough to allow tip 108 to protrude, but the opening is smaller than the width of base 110, thereby retaining base 110 within stem 102.

In some embodiments, probe 106 can be mounted to move bi-directionally in stem 102 by attaching one end of spring 114 to base 110. The other end of spring 114 is attached to stop 116, which provides a platform for compressing spring 114.

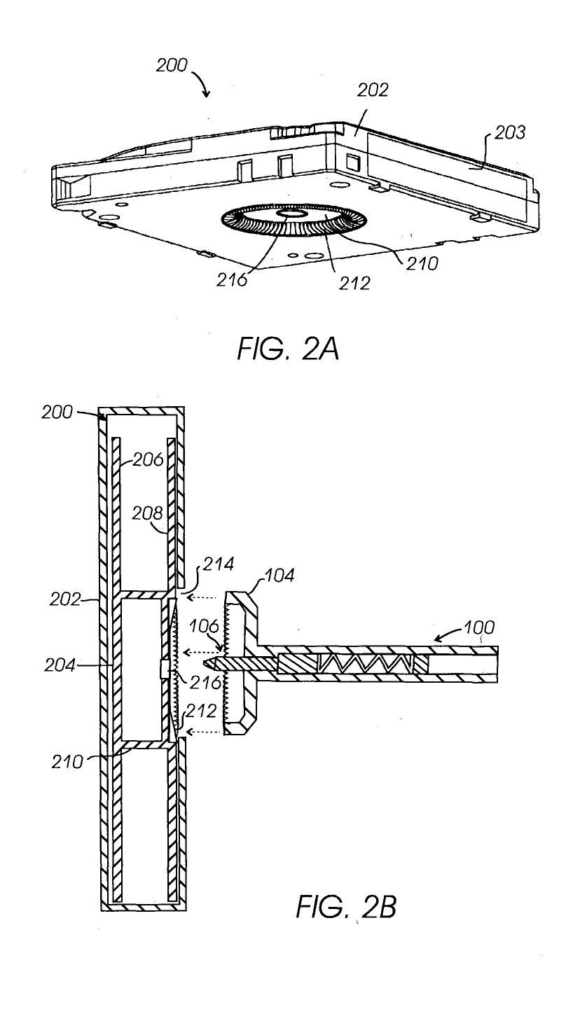

Referring to FIGS. 2A and 2B, FIG. 2A is a perspective view of the bottom of a single spool tape cartridge 200 including housing 202, which encloses a tape spool 204 (FIG. 2B). FIG. 2B is a cross-sectional view of the tape cartridge 200 of FIG. 2A. A sliding door 203 covers a tape access port and leader device parking place (neither of which are shown in the figures). Door 203 slides open to expose the tape access port and thread the tape when cartridge 200 is inserted in a tape drive 500 (FIG. 5).

Tape spool 204 includes disc-shaped flanges 206 and 208 attached to annular spool hub 210. A circular hub gear 212 is positioned at one end of spool hub 210 and is engaged by a mating hub gear 118 (FIG. 1B) around the top edge of hub 104 when cartridge is inserted in tape drive 500 (FIG. 5). Hub gear 212 is accessed by hub 104 through an opening 214 in one side of housing 202. Although hub gear 212 is usually formed as an integral part of spool hub 210, it may be constructed as a discrete component and attached to spool hub 210.

Alignment port 216 for aligning spool 204 when cartridge 200 in tape drive 500 (FIG. 5) is provided in the center of hub 210. One problem that can occur when cartridge 200 is stored with spool 204 oriented in a vertical direction, such as shown, is that spool hub 210 and hub, gear 212 may not be centered in opening 214 of housing 202. This is due to the fact that space must be provided around the perimeter of spool 204 within housing 202 to allow spool 204 to rotate during operation of tape drive 500 (FIG. 5). Since spool 204 is free to rotate within housing 202, the extra space provides room for spool 204 to settle in an off center position, which occurs more frequently when cartridge 200 is oriented on its side.

When hub gear 212 is not centered in opening 214, it frequently can be difficult for spindle hub 104 to engage hub gear 212 due to the mismatched locations of hub 104 and gear 212, as shown by the dashed arrows in FIG. 2B. Several attempts at inserting cartridge 200 may be required before tape drive hub 104 engages hub gear 212 in spool 204, whether cartridge 200 is inserted manually or by an automated robotic device in a storage library. When the mismatch occurs in an automated storage library, the library and tape drive typically execute an error recovery routine in an attempt to re-seat the spool. Sometimes the recovery routine is not successful.

To help avoid the need to re-insert cartridge 200 several times when spool 204 is off-center, the length of alignment probe 106 is such that alignment probe engages opening 216 in spool hub 210 before spindle hub 104 attempts to engage hub gear 212. Tip 108 of alignment probe 106 can be chamfered around the edge to improve the ability of probe 106 to engage opening 216 in hub 204. The dimensions of probe 106, the amount of chamfer around tip 108, and the dimension of opening 216 can be selected based on the typical distance between the center of spool 204 when spool 204 is off-center, and the center of opening 214 in housing 202.

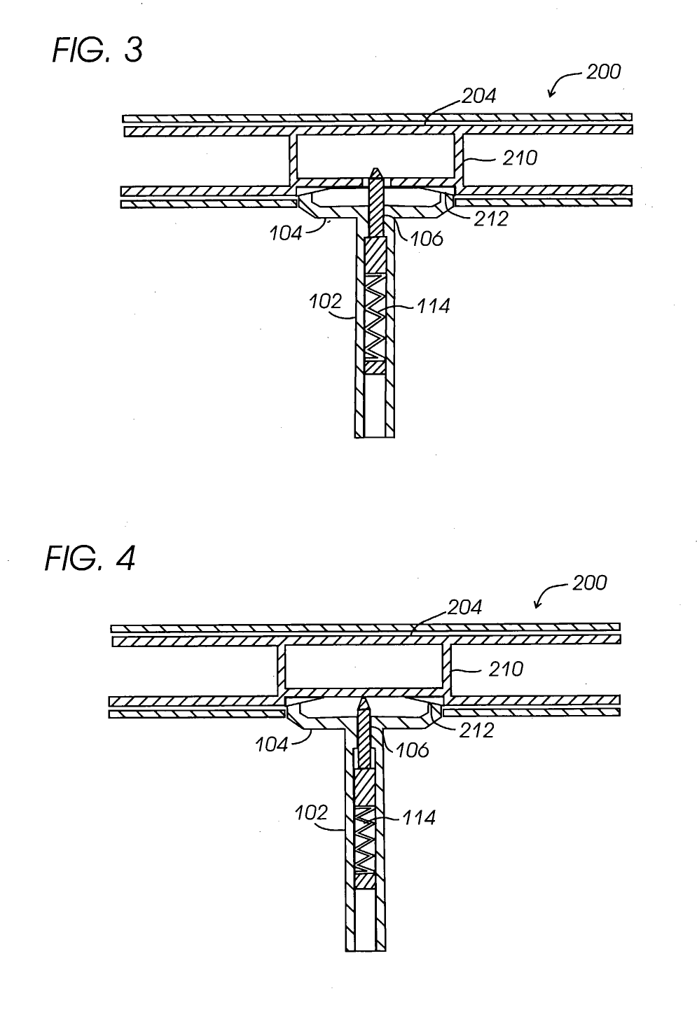

FIG. 3 is a cross-sectional side view of probe 106 engaged in opening 216 after aligning spool gear hub 212 with tape drive hub 104. One skilled in the art can appreciate that probe 106 re-aligns an off-center spool 204 so that it can be engaged and driven by drive hub 104. In many instances, this can help avoid the need to re-insert cartridge 200 multiple times if spool 204 is initially off-center.

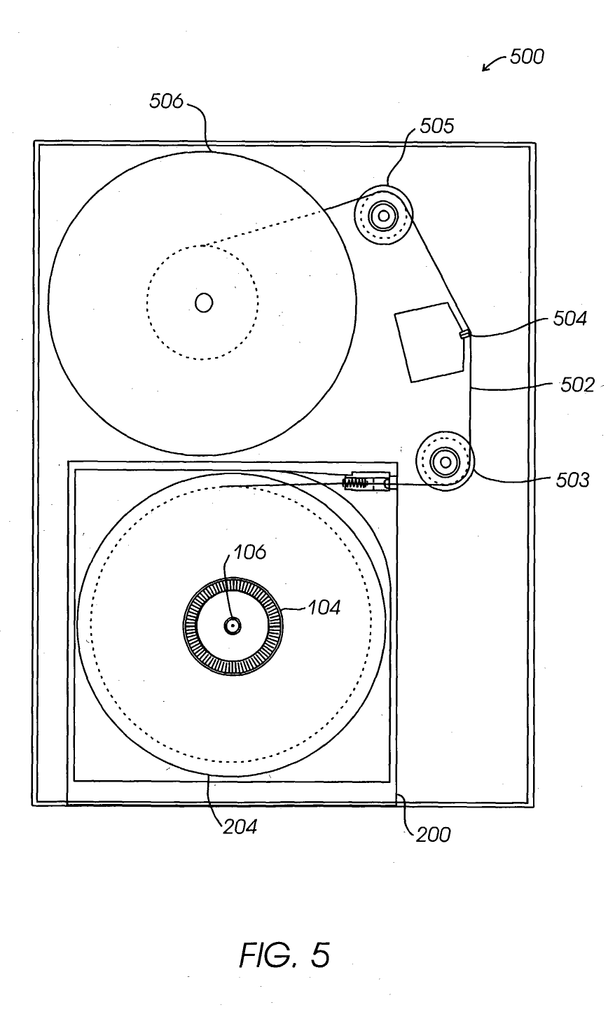

Probe 106 can be spring-loaded to accommodate cartridges 200 that do not include an opening in the center of spool hub 210, such as shown in a cross-sectional side view of cartridge 200 and spindle 100 in FIG. 4. In the embodiment shown, spring 114 is provided in stem 102 to allow probe 106 to depress at least partially into stem 102 of spindle 100 when spool hub 210 does not include opening 216 (FIG. 3).

FIG. 5 is a cut-away top plan diagram of an embodiment a single spool tape drive 500, including tape cartridge 200 inserted therein. Tape 502 is threaded in drive 500 from spool 204 of cartridge 200, around first idler pulley 503, over read/write head 504, around second idler pulley 505, to take-up spool 506 of tape drive 500. Spool 204 is shown as transparent to show the orientation of hub 104 in tape drive 500. When cartridge 200 is inserted, an intake/eject mechanism (not shown) brings cartridge 200 toward hub 104 until hub 104 engages hub gear (not shown) on spool 204. As hub gear 212 (FIG. 2A) is brought toward hub 104, alignment probe 106 enters opening 216 (FIG. 2A), thereby centering spool 204 over hub 104.

Spindle 100 provides a convenient location for positioning alignment probe 106 in tape drive 500. In other embodiments, however, one or more alignment probes 106 can be provided in different locations in tape drive 500, with corresponding openings 216 in cartridges 200. Further, alignment probe 106 may also be configured differently than the embodiment of alignment probe 106 shown in FIG. 1. For example, alignment probe 106 is shown in FIG. 5 with a round cross-section, however, probe 106 can have a square, rectangular, wedge-shaped, or other desired cross-sectional shape.

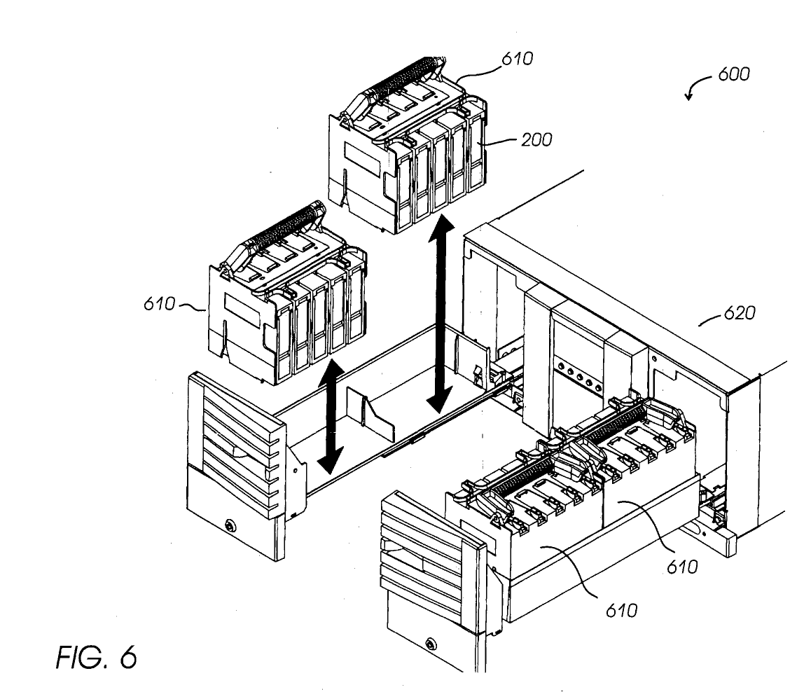

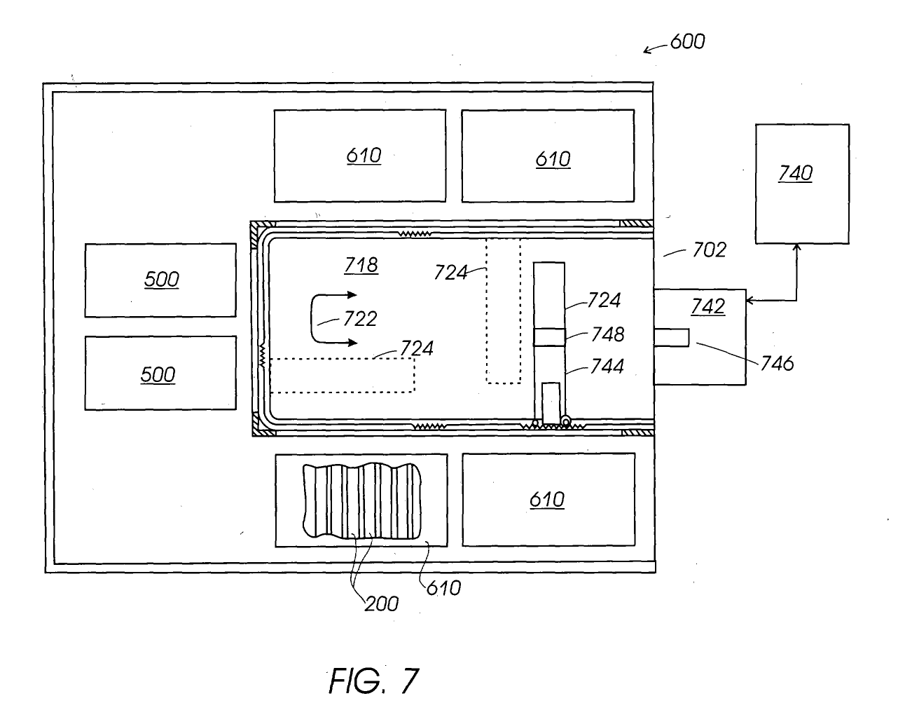

Referring now to FIGS. 6 and 7, an example of a modular storage system 600 in which tape drive 500 (FIG. 5) with spindle 100 (FIG. 1) can be utilized is shown. FIG. 6 shows a partial perspective view of storage system 600, which may include processors and controllers interior to a particular storage system module or group of storage system modules. The illustrative storage system 600 includes cabinet 620 that can hold multiple media storage modules or magazines 610. Each magazine 610 includes a plurality of slots for storing cartridges 200. Typically, cartridges 200 are stored on one side with spools 204 (FIG. 2B) oriented vertically. Over a period of time, spools 204 settle toward the bottom of housings 202 (FIG. 2A), with the result that hub gears 212 (FIG. 2A) are not centered when cartridges 200 are inserted in tape drive 500 (FIG. 5). Further, tape drive 500 is typically oriented to drive spools 204 while spools 204 are vertically oriented. Thus, off-center spools 204 can cause some cartridges 200 to become unusable in drive 500. As a result, data on cartridge may not be accessible unless spool 204 is manually readjusted. Additionally, the storage capacity of storage system 600 will decrease if all of cartridges 200 cannot be utilized.

FIG. 7 shows a top schematic view storage system 600 that includes a cartridge handling system 702 for transferring cartridges 200 between magazines 610, and one or more tape drives 500. Although other configurations are possible, magazines 610 and tape drives 500 may be positioned at various locations around the cartridge handling system 702 so that they define the generally U-shaped configuration shown in FIG. 7.

Cartridge handling system 702 includes cartridge access device 724 capable of loading and retrieving cartridges 200 from magazines 706 and tape drives 500. Cartridge access device 724 moves along U-shaped path 722.

In operation, storage system 600 can be used to transfer a plurality of cartridges 200 between magazines 610 and tape drives 500 positioned around U-shaped path 722. Therefore, cartridge storage system 600 can be used by host computer system 740, for example, or other data processing system to store and access data contained in cartridges 200. Host computer system 740 issues requests for access to particular data, and to store data, to system controller 742. System controller 742 determines which cartridge(s) 200 to use to fulfill the request from host computer system 740, and transmits commands to-cartridge access device 724 via wireless communications device 746, which communicates with wireless communications device 748 on cartridge access device 724.

A controller 744 associated with cartridge access device 724 receives the commands from communications device 748, and controls an actuator system on cartridge access device 724 as necessary to move cartridge access device 724 along the U-shaped path 722 until cartridge access device 724 is located adjacent the appropriate cartridge 200. Controller 744 transmits status information to system controller 742 so that system controller 742 can notify host computer 740 when a request has been fulfilled.

For example, consider an initial condition wherein the desired cartridge 200 is stored in one of cartridge storage racks or magazines 610. Upon receiving a request for cartridge 200 from system controller 742, cartridge access device 724 moves along U-shaped path 722 until cartridge access device 724 is adjacent a selected cartridge 200 in magazine 610. A cartridge engaging device or “picker” (not shown) associated with cartridge access device 724 then engages cartridge 200 and draws it into cartridge access device 724. Cartridge access device 724 moves to a desired tape drive 500. Once properly positioned adjacent the desired tape drive 500, the cartridge engaging assembly or picker (not shown) associated with cartridge access device 724 loads cartridge 200 into cartridge read/write device 708. Host computer system 740 is configured to have access to the data on cartridge 200 once cartridge 200 is loaded into tape drive 500.

System controller 742 also monitors the operation of tape drives 500, determines whether additional cartridges are required to complete the request from host computer 740. For example, if several cartridges are required to complete a backup operation for host computer 740, system controller 742 commands cartridge access device 724 to remove full cartridges 200 from tape drives 500, return the cartridges 200 to an assigned slot in magazine 610, retrieve another cartridge 200, and insert cartridge 200 in drive 500 until the backup request is fulfilled.

Thus, modular storage system 600 allows automated storage and retrieval of data from cartridges 200 for host computer 740. Centering means, such as spindle 100, for centering hub gears 212 (FIG. 2A) in cartridges 200, allows storage system 600 to operate more efficiently, as hub gears 212 are centered over hubs 104 by alignment probe 106 as cartridges 200 are inserted in tape drives 500. Spindle 100 with alignment probe 106 can also be utilized in manually operated tape drives 500, as well as various types of drive systems, such as friction drives and manually loaded tape drives 500, where hub 210 of cartridge 200 must be aligned with hub 104 in tape drive 500 for proper operation.

The logic modules and circuitry described here may be implemented using any suitable combination of hardware, software, and/or firmware, such as Field Programmable Gate Arrays (FPGAs), Application Specific Integrated Circuit (ASICs), or other suitable devices. A FPGA is a programmable logic device (PLD) with a high density of gates. An ASIC is a microprocessor that is custom designed for a specific application rather than a general-purpose microprocessor. The use of FPGAs and ASICs improves the performance of the system over general-purpose CPUs, because these logic chips are hardwired to perform a specific task and do not incur the overhead of fetching and interpreting stored instructions. The logic modules and other components have been discussed as separate and discrete components. These components may, however, be combined, if desired.

While the invention has been described with reference to various embodiments, it will be understood that these embodiments are illustrative and that the scope of the invention is not limited to them. Many variations, modifications, additions and improvements of the embodiments described are possible. For example, those having ordinary skill in the art will readily implement the steps necessary to provide the structures and methods disclosed herein, and will understand that the components and their arrangement are given by way of example only. The configurations can be varied to achieve the desired structure as well as modifications, which are within the scope of the invention. Variations and modifications of the embodiments disclosed herein may be made based on the description set forth herein, without departing from the scope of the invention as set forth in the following claims.

1. A storage device comprising:
a tape drive;
a spindle in the tape drive; as
a probe positioned in the spindles; and
a tape cartridges wherein the probe engages an opening in the center of a hub in the cartridge as the cartridge is inserted in the tape drive.

2. A storage device according to claim 1 wherein the spindle includes:
a hollow stem;
a spring in the hollow stem; and
a stop portion positioned in one end of the hollow stem, wherein one end of the spring is coupled to the stop portion to provide a platform for compressing the spring.

3. A storage device according to claim 2 wherein the probe is coupled to the other end of the spring,

4. A storage device according to claim 3 wherein the probe includes a tip, and one end of the rip is chamfered to engage the opening in the center of the cartridge hub.

5. A storage device according to claim 4 wherein the probe further includes a base portion coupled to another end of the tip, the width of the base portion being larger than the width of the tip.

6. A storage device according to claim 5 further comprising:
another stop portion at another end of the hollow stem, wherein the stop portion includes an opening that is dimensioned to allow the tip portion of the probe to protrude through the opening, while retaining the base portion of the probe within the hollow stem.

7. A storage device according to claim 4 wherein the spring is oriented to compress to retract the probe when a cartridge without an opening in the center of the cartridge hub is inserted in the tape drive.

8. A storage device according to claim 4 wherein the spring is oriented to extend the tip of the probe through the opening in the center of the cartridge hub when the cartridge is inserted in the tape drive.

9. A storage device according to claim 8 wherein the tip of the probe and the chamfer at the end of the tip are dimensioned to engage the opening in the cartridge hub to align the cartridge hub with the tape drive hub.

10. A storage device according to claim 1 further comprising:
an access device, wherein the access device is automatically controllable to insert the cartridge in the tape drive.

11. A method for aligning a cartridge hub in a tape drive, wherein the cartridge includes an opening for receiving an alignment probe, the method comprising:
mounting the alignment probe in the tape drive so that the alignment probe engages the opening in the cartridge to align the cartridge hub with a desired position as the cartridge is inserted in the tape drive.

12. A method according to claim 1I wherein the alignment probe is spring-loaded, and the tape drive can accept cartridges with and without the opening.

13. A method according to claim 11 wherein the opening is positioned in the cartridge hub.

14. A method according to claim 11 wherein one end of the alignment probe is chamfered to engage the opening in the cartridge hub when the cartridge hub is off-center.

15. A method according to claim 11 wherein the alignment probe is positioned in a spindle in the tape drive.

16. A device for aligning a hub comprising:
the hub,
a spindle, wherein the spindle is operable to rotate the hub; and
a spring-loaded alignment probe mounted in the spindle, wherein the alignment probe engages an opening in the hub.

17. A device according to claim 16 further comprising:
a tape drive, wherein the spindle is mounted in the tape drive.

18. A device according to claim 17 further comprising:
at least one cartridge, wherein the cartridge includes the hub in the center of a spool, and the cartridge is utilized with the diameter of the hub oriented at least partially vertically.

19. A device according to claim 18 further comprising:
an access device, wherein the access device is automatically controllable to insert the cartridge in the tape drive.

20. A device according to claim 19 wherein the tip of the probe extends through the opening in the hub, and the probe depresses at least partially into the spindle when the hub does not include the opening.

21. An apparatus comprising:
a cartridge:
means for mounting an alignment probe so that the alignment probe engages an opening in the a cartridge; and
means for spring-loading the probe.

22. An apparatus according to claim 21 further comprising:
a tape drive, wherein the tape drive includes the means for mounting the alignment probe.

23. An apparatus according to claim 21 further comprising:
at least one cartridge, wherein the cartridge includes a hub; and
an access device, wherein the access device is automatically controllable to insert the cartridge in the tape drive.

24. An apparatus according to claim 21 wherein the tip of the probe extends through the opening in the cartridge, and the probe depresses at least partially into the means for mounting the alignment probe when the hub does not include the opening.
